(19) United States
(12) Patent Application Publication
(10) Pub. No.: US 2015/0271648 A1
(43) Pub. Date: Sep. 24, 2015

(54) DISTRIBUTED ANTENNA IN-DOOR LOCATING SYSTEM AND ITS LOCATING METHOD

(71) Applicant: Amoesolu Corporation, Taipei (TW)

(72) Inventors: Terng-Yin HSU, Taipei (TW); Cheng-Yen CHEN, Taipei (TW); Wen-Jye HUANG, Taipei (TW); Ray-Shiang JEAN, Taipei (TW); Shao-Ying YEH, Taipei (TW)

(73) Assignee: AMOESOLU CORPORATION, Taipei (TW)

(21) Appl. No.: 14/223,748

(22) Filed: Mar. 24, 2014

(51) Int. Cl. H04W 4/04; H01Q 1/24

(52) U.S. Cl. CPC H04W 4/04; H01Q 1/246

(57) ABSTRACT

A distributed antenna in-door locating system has multiple antenna units, a head unit and a locating unit. The head unit is wired connected to the multiple antenna units respectively to assign a RF communication band to each user device. The locating unit is connected to the head unit and has a build-in locating process comprising steps of: (a) reading the assigned RF communication bands, and signal strength of RF signals in the assigned RF communication bands. (b) determining a location of each user device based on the assigned RF communication bands of each antenna unit and the signal strength of RF signals in the assigned RF communication bands. A administrator of the distributed antenna in-door locating system can obtain the location of each user device, and further obtain suitable locations for mounting the multiple antenna units in the area.

### BACKGROUND OF THE INVENTION

1. Field of the Invention

The present invention relates to a locating system and its locating method and more particularly to a distributed antenna in-door locating system and its locating method.

2. Description of Related Art

The distributed antenna system (DAS) has a head unit and multiple antenna units. The head unit is wired connected to a telecommunication base station. The multiple antenna units are wired connected to the head unit, and respectively provide a DAS converge area for a telecommunication network.

Generally, the DAS aims to provide a telecommunication network for user devices such as cell phones or laptops within in-door areas such as subways or buildings having no wireless signals of conventional telecommunication networks.

When multiple user devices are wirelessly connected to the DAS, the head unit respectively assigns multiple radiofrequency (RF) communication bands to the multiple user devices by the multiple antenna units, that is, each user device transmits/receives RF signals to the multiple antenna units in a corresponding one of the multiple RF communication bands. Then the multiple antenna units transmit/receive RF signals of each user device via the head unit.

However, a distribution of the multiple antenna units of the DAS is only focus on providing a telecommunication network converging whole in-door area. When too many user devices are wirelessly connected to the telecommunication network of the DAS at a same location in the in-door area simultaneously, the multiple antenna units mounted at the location may be unable to afford all connection requirements from the user devices at the location simultaneously. Therefore, a connection quality between the user devices at the location and the telecommunication network of the DAS deteriorates.

### SUMMARY OF THE INVENTION

The main objective of the invention is to provide a distributed antenna in-door locating system.

The distributed antenna in-door locating system comprises multiple antenna units, a head unit and a locating unit. The multiple antenna units respectively have multiple RF communication bands and communicate with the user devices transmitting connection requirements in RF ranges of the multiple antenna units. The head unit is wired connected to a telecommunication base station, wherein the head unit is wired connected to the multiple antenna units to respectively assign one of the multiple RF communication bands to each user device via the multiple antenna units. The locating unit is connected to the head unit and has a build-in locating process comprising steps of: (a) reading the assigned RF communication bands, and signal strength of RF signals in the assigned RF communication bands. (b) determining a location of each user device based on the assigned RF communication bands and the signal strength of RF signals in the assigned RF communication bands.

Another main objective of the invention is to provide a locating method for the distributed antenna in-door locating system.

The locating method for the distributed antenna in-door locating system comprises steps of:

(a) mounting a head unit and multiple antenna units of a DAS at different locations of an area to form a telecommunication network in the area, wherein the head unit is wired connected to a telecommunication base station and the multiple antenna units;

(b) searching user devices transmitting connection requirements in the telecommunication network by the multiple antenna units transmitting/receiving RF signals in multiple RF communication bands, and then reporting to the head unit when a user device is found in the telecommunication network by the multiple antenna units;

(c) assigning one of the multiple RF communication bands to each user device found in the telecommunication network by the head unit;

(d) reading the assigned RF communication bands, and signal strength of RF signals in the assigned RF communication bands; and

(e) determining a location of each user device found in the telecommunication network based on the assigned RF communication bands and the signal strength of RF signals in the assigned RF communication bands.

By the distributed antenna in-door locating system in accordance with the present invention and its locating method, a administrator of the DAS can determine locations of user devices wirelessly connected to the telecommunication network of the DAS, such that, the administrator can obtain which locations converged by the telecommunication network of the DAS in the area are tend to be crowded with user devices wirelessly connected to the telecommunication network. The administrator of the DAS can mount more antenna units of the DAS near the locations to reduce a burden of each antenna unit at the locations and further improve a connection quality between the user devices at the locations and the telecommunication network of the DAS.

### BRIEF DESCRIPTION OF THE DRAWINGS

FIG. 1A is a schematic view of a floor of a building having a preferred embodiment of a distributed antenna in-door locating system in accordance with the present invention at a first time point;

FIG. 1B is another schematic view of the floor of the building having the in-door locating system in FIG. 1A at a second time point;

FIG. 2 is a flow chart of a locating process of a locating unit of the in-door locating system in FIG. 1A;

FIG. 3A is a table showing RF signal strength of RF signals received by each antenna unit of the in-door locating system in FIG. 1A;

FIG. 3B is a table showing RF signal strength of RF signals received by each antenna unit of the in-door locating system in FIG. 1B; and

FIG. 4 is a flow chart of a preferred embodiment of a locating method in accordance with the present invention.

### DETAILED DESCRIPTION OF THE PREFERRED EMBODIMENTS

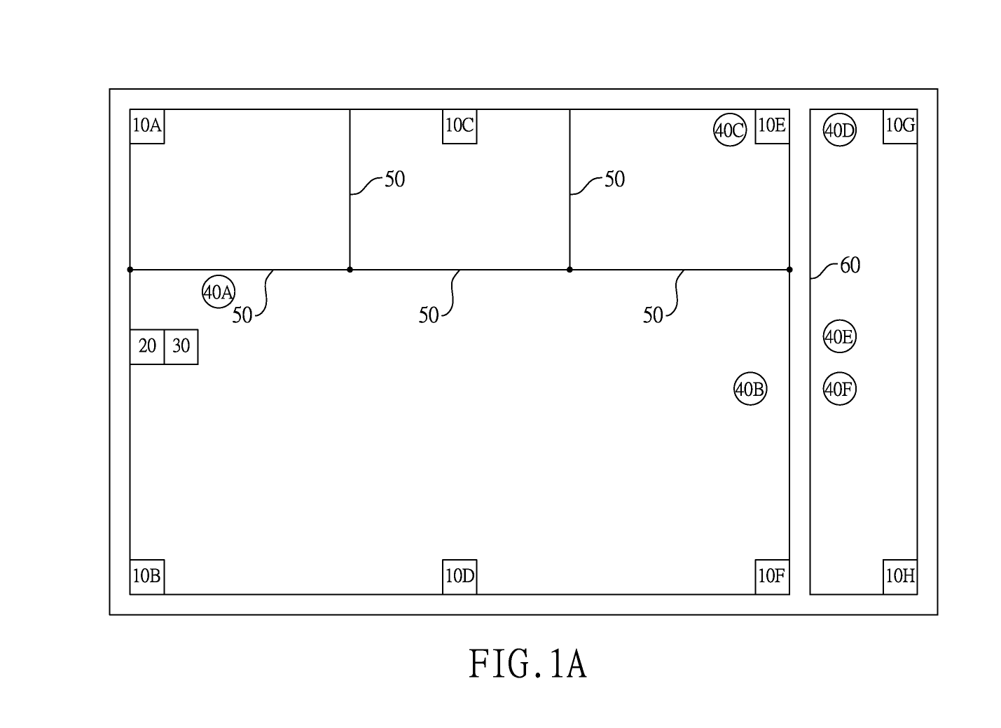

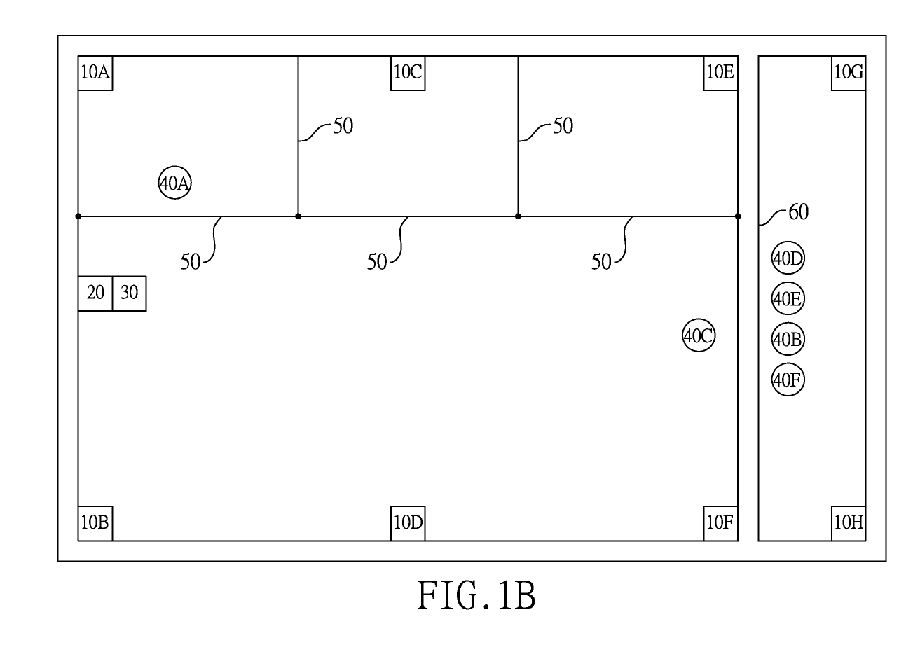

With reference to FIGS. 1A and 1B, a preferred embodiment of a distributed antenna in-door locating system in accordance with the present invention comprises eight antenna units 10A˜10H, a head unit 20 and a locating unit 30.

With reference to FIG. 1A, the distributed antenna in-door locating system is provided in a floor of a building, wherein the floor has multiple wooden walls 50 and a cement wall 60, and six user devices 40A˜40F are distributed at different locations in the floor. FIG. 1B is another schematic view of the floor showing locations of the six user devices 40A˜40F in the floor in FIG. 1A after a short time. The user devices 40A, 40B, 40C, 40D in FIG. 1B change their locations from original locations in FIG. 1A, and the user devices 40E and 40F stay at the same locations.

The eight antenna units 10A˜10H are mounted at different locations in the floor of the building. Each antenna unit 10A˜10H has multiple RF communication bands and communicates with the six user devices 40A˜40F.

The head unit 20 is mounted in the floor of the building, and is wired connected to a telecommunication base station. The head unit 20 is wired connected to the eight antenna units 10A˜10H respectively to further communicate with the six user devices 40A˜40F via the eight antenna units 10A˜10H. Then, each user device 40A˜40F is assigned one of the multiple RF communication bands of the multiple eight antenna units 10A˜10H, that is, the user devices 40A˜40F transmits/receives RF signals to the eight antenna units in the RF communication band. The locating unit 30 is connected to the head unit 20 and has a build-in locating process. In this preferred embodiment, six RF communication bands 0˜100 Hz, 100˜200 Hz, 200˜300 Hz, 300˜400 Hz, 400˜500 Hz and 500˜600 Hz of the eight antenna units 10A˜10H are respectively assigned to the six user devices 40A˜40F by the head unit 20.

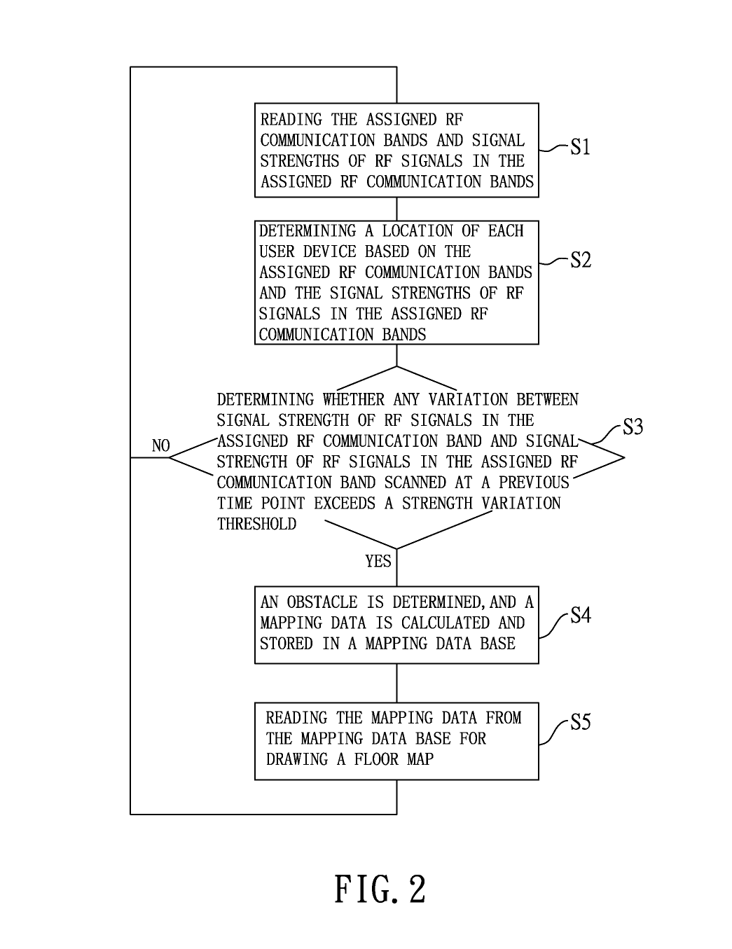

With further reference to FIG. 2, when the distributed antenna in-door locating system is turned on, the locating unit 30 locates the six user devices 40A˜40F by the build-in locating process having steps of:

Reading the assigned RF communication bands, and signal strength of RF signals in the assigned RF communication bands (S1).

Determining a location of each user device 40A˜40F based on the assigned RF communication bands and the signal strength of RF signals in the assigned RF communication bands (S2).

Determining whether any variation between signal strength of RF signals in the assigned RF communication bands and signal strength of RF signals in the assigned RF communication band scanned at a previous time point exceeds a strength variation threshold (S3).

When the variation between signal strength of RF signals in each assigned RF communication bands and signal strength of RF signals in the assigned RF communication band scanned at the previous time point exceeds the strength variation threshold, an obstacle is determined between a current location and a previously detected location of the user device 40A˜40F occupying the assigned RF communication band. Mapping data is calculated based on the obstacle determining result and is stored in a mapping database (S4).

Reading the mapping data from the mapping database for drawing a map of the floor (S5).

A detail of the locating process of the locating unit 30 will be revealed by following paragraph.

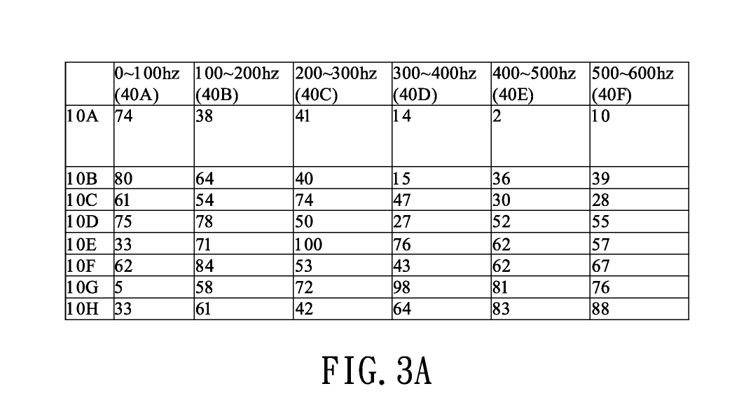

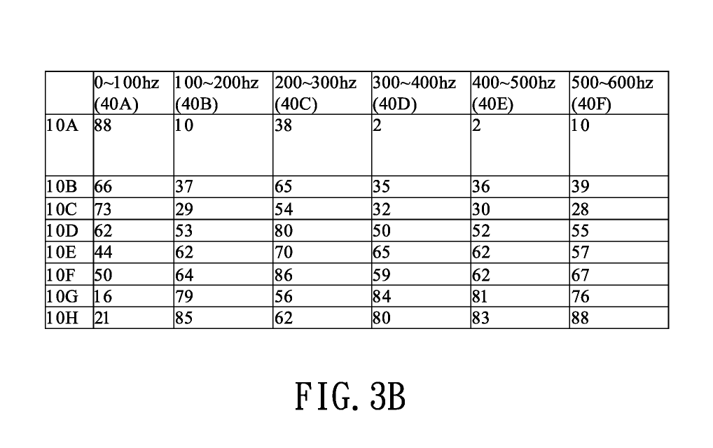

In the step (S1), with reference to FIGS. 3A and 3B, column headings from top to bottom sequentially correspond to the eight antenna units 10A˜10H, and row headings sequentially correspond to the multiple RF communication bands of each antenna unit 10A˜10H assigned to the six user devices 40A˜40F. A value in each table field represents signal strength of RF signals received by an antenna unit 10A˜10H corresponding to a column heading of the table field and in a RF communication band assigned to a user device 40A˜40F corresponding to a row heading of the table field, wherein a unit of the value in each table field is 10−3 dB.

In the step (S2), by observing positions of the user device 40D in FIGS. 1A and 1B, and a variation of signal strength of RF signals of the user device 40D received by the antenna units 10E, 10G, 10F in FIGS. 3A and 3B, one can obtain that signal strength of RF signals of each user device 40A˜40F received by the eight antenna units 10A˜10H is inversely proportional to a distance between the user device 40A˜40F and the eight antenna units 10A˜10H. That is, when a location of each user device 40A˜40F becomes closer to the eight antenna units 10A˜10H, the signal strength of RF signals of the user device 40A˜40F received by the eight antenna units 10A˜10H becomes stronger. Therefore, the locating unit 30 calculates a relative distance between each user device 40A˜40F and the eight antenna units 10A˜10H based on the assigned RF communication bands, and signal strength of RF signals in the assigned RF communication bands read in step (S1), and then determines a location of each user device 40A˜40F by conventional locating method such as triangulation location method, but not limits to this.

In steps (S3) and (S4), with reference to FIGS. 1A and 3A, the user device 40A and the antenna unit 10A is separated by a wooden wall 50, a signal strength of RF signals of the user device 40A received by the antenna unit 10A is 74*10⁻³ dB, with further reference to FIGS. 1B and 3B, the user device 40A and the antenna unit 10A is not separated by any obstacle, the signal strength of RF signals of the user device 40A received by the antenna unit 10A is increased to 88*10⁻³ dB, while relative distances between the user device 40A and the antenna unit 10A are almost the same in FIGS. 1A and 1B.

With reference to FIGS. 1A and 3A, the user device 40A and the antenna unit 10B is not separated by any obstacle, a signal strength of RF signals of the user device 40A received by the antenna unit 10B is 80*10⁻³ dB, with further reference to FIGS. 1B and 3B, the user device 40A and the antenna unit 10B is further separated by a wooden wall 50, the signal strength of RF signals of the user device 40A received by the antenna unit 10B is decreased to 66*10⁻³ dB, while relative distances between the user device 40A and the antenna unit 10B are almost the same in FIGS. 1A and 1B.

By the above two paragraphs, one can obtain that when each user device 40A˜40F and the eight antenna units 10A˜10H is further separated by a wooden wall 50, signal strength of RF signals of the user device 40A˜40F received by the eight antenna units 10A˜10H are roughly decreased by 10*10⁻³ dB.

With reference to FIGS. 1A and 3A, the user device 40B and the antenna unit 10G is separated by the cement wall 60, a signal strength of RF signals of the user device 40B received by the antenna unit 10G is 58*10⁻³ dB. With further reference to FIGS. 1B and 3B, the user device 40B and the antenna unit 10G is not separated by any obstacle, the signal strength of RF signals of the user device 40B received by the antenna unit 10G is increased to 79*10⁻³ dB, while relative distances between the user device 40B and the antenna unit 10G are almost the same in FIGS. 1A and 1B.

With reference to FIGS. 1A and 3A, the user device 40B and the antenna unit 10H is separated by the cement wall 60, a signal strength of RF signals of the user device 40B received by the antenna unit 10H is 61*10⁻³ dB. With further reference to FIGS. 1B and 3B, the user device 40B and the antenna unit 10H is not separated any obstacle, the signal strength of RF signals of the user device 40B received by the antenna unit 10H is increased to 85*10⁻³ dB, while relative distances between the user device 40B and the antenna unit 10H are almost the same in FIGS. 1A and 1B.

By the above two paragraphs, one can obtain that when each user device 40A˜40F and the eight antenna units 10A˜10H is further separated by the cement wall 60, signal strength of RF signals of the user device 40A˜40F received by the eight antenna units 10A˜10H are roughly decreased by 20*10⁻³ dB.

In conclusion, when each user device 40A˜40F and the eight antenna units 10A˜10H is further separated by an obstacle such as the wooden wall 50 or the cement wall 60, the signal strength of RF signals of the user device 40A˜40F received by the eight antenna units 10A˜10H are decreased, wherein a decrease of the signal strength is based on a material of the obstacle between the user device 40A˜40F and the eight antenna units. For example, the cement wall 60 decreases more signal strength than the wooden wall 50.

Generally, a variation of the signal strength of RF signals of each user device 40A˜40F received by the eight antenna units 10A˜10H caused by obstacle blocking are much larger than a variation of the signal strength of RF signals of each user device 40A˜40F received by the eight antenna units 10A˜10H caused by a variation of relative distance between the user device 40A˜40F and the eight antenna units 10A˜10H within two close time points. Because each user device 40A˜40F is able to cross an obstacle between each user device 40A˜40F and the eight antenna units 10A˜10H by a user carrying the user device 40A˜40F entering/leaving a room or moving around a corner within two close time points, while the variation of relative distance between each user device 40A˜40F and the eight antenna units 10A˜10H is limited to a moving speed of the user carrying the user device 40A˜40F within two close time points.

Therefore, when any variation between signal strength of RF signals in each assigned RF communication bands and signal strength of RF signals in the assigned RF communication band scanned at a previous time point exceeds a strength variation threshold of the locating unit 30, an obstacle is determined between a location of the user device 40A˜40F occupying the assigned RF communication band and a location of the user device 40A˜40F occupying the assigned RF communication band scanned at the previous time point, and a mapping data is calculated based on the obstacle determining result and is stored in a mapping database of the locating unit 30.

In the step (S5), the locating unit 30 reads the mapping database and draws a map of the floor of the building having the distributed antenna in-door locating system based on the mapping data.

By the steps (S3)˜(S5), a administrator of the distributed antenna in-door locating system can adjust an amount of the eight antenna units 10A˜10H or a distribution of the eight antenna units 10A˜10H based on a distribution of obstacles influencing signal strength of RF signals.

In conclusion, by the distributed antenna in-door locating system, a administrator of the distributed antenna in-door locating system can obtain which locations in the floor converged by the telecommunication network of the distributed antenna in-door locating system are tend to be crowded with user devices wirelessly connected to the telecommunication network. The administrator of the distributed antenna in-door locating system can mount more antenna units of the DAS near the locations to reduce a burden of each antenna unit at the locations and further improve a connection quality between the user devices at the locations and the telecommunication network of the distributed antenna in-door locating system.

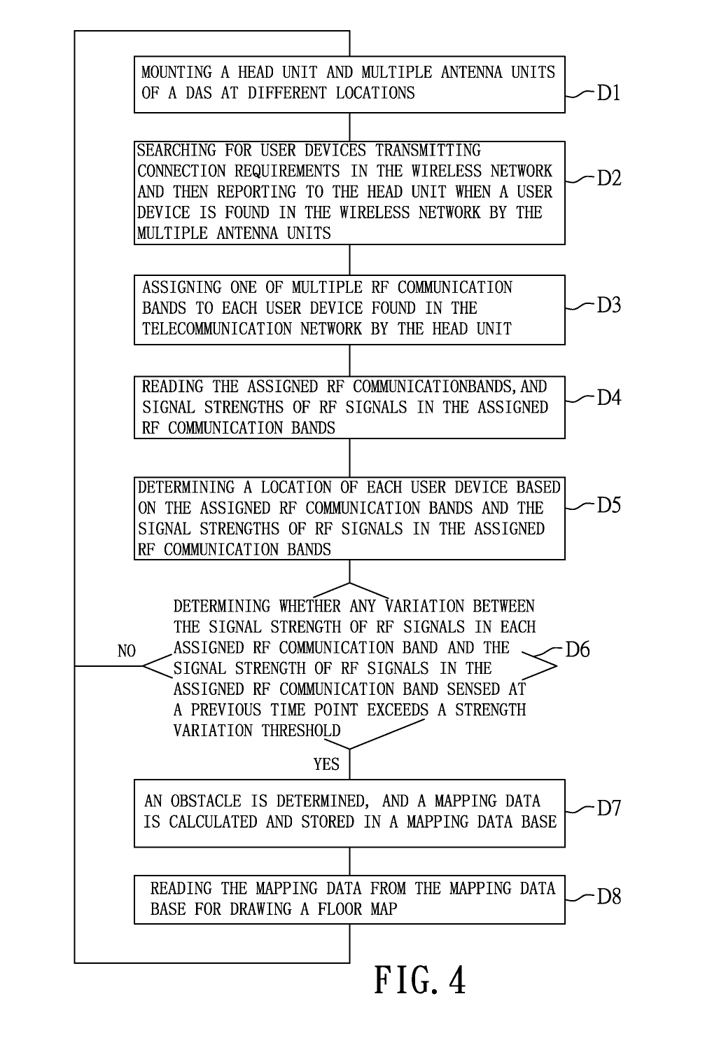

Furthermore, with reference to FIG. 4, a preferred embodiment of a locating method in accordance of the present invention comprises steps of:

Mounting a head unit and multiple antenna units of a DAS at different locations of an area to form a telecommunication network in the area, wherein the head unit is wired connected to a telecommunication base station and the multiple antenna units (D1).

Searching user devices transmitting connection requirements in the telecommunication network by the multiple antenna units transmitting/receiving RF signals in multiple RF communication bands, and then reporting to the head unit when a user device is found in the telecommunication network by the multiple antenna units (D2).

Assigning one of the multiple RF communication bands to each user device found in the telecommunication network by the head unit (D3).

Reading the assigned RF communication bands, and signal strength of RF signals in the assigned RF communication bands (D4).

Determining a location of each user device found in the telecommunication network based on the assigned RF communication bands and the signal strength of RF signals in the assigned RF communication bands (D5).

Determining whether any variation between signal strength of RF signals in each assigned RF communication band and signal strength of RF signals in the assigned RF communication band scanned at a previous time point exceeds a strength variation threshold (D6).

When the variation between signal strength of RF signals in each assigned RF communication bands and signal strength of RF signals in the assigned RF communication band scanned at the previous time point exceeds the strength variation threshold, an obstacle is determined between a current location and a previously detected location of the user device occupying the assigned RF communication band. Mapping data is calculated based on the obstacle determining result and is stored in a mapping database (D7).

Reading the mapping data from the mapping database for drawing a map of the floor (D8).

A detail of the locating method will be revealed by following paragraph.

In the steps (D1)˜(D3), the DAS is provided in an area to provide a DAS converge area for a telecommunication network by the head unit and the multiple antenna units of the DAS. Then, each user device communicates with the telecommunication network of the DAS via one of the multiple antenna units.

The steps (D4) and (D5) are respectively corresponding to the above steps (S1) and (S2) of the locating process, wherein a location of each user device is calculated by conventional locating method such as triangulation location method and based on signal strength of RF signals of the user device.

The steps (D6)˜(D8) are respectively corresponding to the above steps (S3)˜(S5) of the locating process, and the object of steps (D6)˜(D8) is for drawing a map of the area showing a distribution of obstacles influencing signal strength of RF signals in the area.

The locating method has similar advantages as the distributed antenna in-door locating system, thus, a administrator of the DAS can also obtain the location of each user device in the area by the locating method, and further obtain suitable locations for mounting the multiple antenna units of the DAS in the area.

Above all, a administrator of the DAS can determine locations of user devices wirelessly connected to the telecommunication network of the DAS, such that, the administrator can obtain which locations converged by the telecommunication network of the DAS in the area are tend to be crowded with user devices wirelessly connected to the telecommunication network (such as a location between the antenna units 10G and 10H In FIG. 1A). The administrator of the DAS can mount more antenna units of the DAS near the locations to reduce a burden of each antenna unit at the locations and further improve a connection quality between the user devices at the locations and the telecommunication network of the DAS.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A distributed antenna in-door locating system comprising:
multiple antenna units respectively having multiple RF communication bands and communicating with user devices transmitting connection requirements in RF ranges of the multiple antenna units;
a head unit wired connected to a telecommunication base station and the multiple antenna units to respectively assign one of the multiple RF communication bands to each user device via the multiple antenna units; and
a locating unit connected to the head unit and having a build-in locating process, the locating process comprising steps of:
(a) reading the assigned RF communication bands, and signal strength of RF signals in the assigned RF communication bands; and
(b) determining a location of each user device based on the assigned RF communication bands and the signal strength of the RF signals in the assigned RF communication bands.

2. The distributed antenna in-door locating system as claimed in claim 1, wherein the locating unit further comprises a build-in mapping database and a build-in strength variation threshold, and after the step (b) of the locating process, the locating process further comprises steps of:
(c) determining whether any variation between the signal strength of the RF signals in each assigned RF communication band and the signal strength of the RF signals in the assigned RF communication band scanned at a previous time point exceeds the strength variation threshold;
(d) when the variation between signal strength of RF signals in each assigned RF communication band and signal strength of RF signals in the RF communication band scanned at the previous time point exceeds the strength variation threshold, an obstacle is determined between a current location and a previously detected location of the user device occupying the assigned RF communication band, mapping data is calculated based on the obstacle determining result and are stored in a mapping database; and
(e) reading the mapping data from the mapping database for drawing a map of the floor.

3. The distributed antenna in-door locating system as claimed in claim 1, wherein in the step (b), the location of each user device is calculated by triangulation location method.

4. The distributed antenna in-door locating system as claimed in claim 2, wherein in the step (b), the location of each user device is calculated by triangulation location method.

5. A locating method comprising steps of:
(a) mounting a head unit and multiple antenna units of a DAS at different locations of an area to form a telecommunication network in the area, wherein the head unit is wired connected to a telecommunication base station and the multiple antenna units;
(b) searching user devices transmitting connection requirements in the telecommunication network by the multiple antenna units transmitting/receiving RF signals in multiple RF communication bands, and then reporting to the head unit when a user device is found in the telecommunication network by the multiple antenna units;
(c) assigning one of the multiple RF communication bands to each user device found in the telecommunication network by the head unit;
(d) reading the assigned RF communication bands, and signal strength of RF signals in the assigned RF communication bands; and
(e) determining a location of each user device found in the telecommunication network based on the assigned RF communication bands of each antenna unit and the signal strength of RF signals in the assigned RF communication bands.

6. The locating method as claimed in claim 5, after the step (e), further comprising steps of:
(f) determining whether any variation between signal strength of RF signals in each assigned RF communication band and signal strength of RF signals in the assigned RF communication band scanned at a previous time point exceeds a strength variation threshold;
(g) when the variation between signal strength of RF signals in each assigned RF communication band and signal strength of RF signals in the assigned RF communication band scanned at the previous time point exceeds the strength variation threshold, an obstacle is determined between a current location and a previously detected location of the user device occupying the assigned RF communication band, mapping data is calculated based on the obstacle determining result and are stored in a mapping database; and
(h) reading the mapping data from the mapping database for drawing a map of the floor.

7. The locating method as claimed in claim 5, wherein in the step (e), the location of each user device is calculated by triangulation location method.

8. The locating method as claimed in claim 6, wherein in the step (e), the location of each user device is calculated by triangulation location method.
